(19) United States
(12) Patent Application Publication
(10) Pub. No.: US 2008/0252069 A1
(43) Pub. Date: Oct. 16, 2008

(54) Female element for a connector and connector comprising such a female element

(75) Inventors: Alain-Christophe Tiberghien, Sevrier (FR); Olivier Pastore, Faverges (FR)

Correspondence Address: Ralph A. Dowell of DOWELL & DOWELL P.C., 2111 Eisenhower Ave, Suite 406, Alexandria, VA, 22314, US

(73) Assignee: STAUBLI FAVERGES, Faverges (FR)

(21) Appl. No.: 12/078,877

(22) Filed: Apr. 7, 2008

(30) Foreign Application Priority Data
Apr. 10, 2007 (FR) 07 02594

(51) Int. Cl. F16L 37/23

(52) U.S. Cl. 285/81

(57) ABSTRACT

Female element (103) for a connector (101), having an axial (X-X′) channel (130) intended to accommodate an end piece (102), the female element having an annular element (139) and at least one locking ball (150A-150C) for locking the end piece (102) that can move axially (X-X′) relative to the annular element (139) and radially between an unlocked position (FIG. 3) and a locked position in which it is capable of axially blocking (X-X′) the end piece (102). This female element (103) further includes:

at least one device forming an obstacle to the axial displacement (X-X′) of the annular element (139) relative to the ball (150A-150C) in the unlocked position, said device being radially retractable;

at least one resilient element (152) for returning the device (152) to the unlocked position; and

at least one detection member (151A-151D) for detecting the end piece (102), that is capable, in the unlocked position, of being moved away radially by the end piece (102) so as to retract said device (152).

In addition, this device and this resilient element consist of a stop clip (152) in the form of a resilient ring consisting of a wire of circular cross section.

The present invention relates to a female element for a connector intended for removably joining two fluid pipes. The invention also relates to a quick-fit connector comprising such a female element.

A quick-fit connector conventionally comprises a male end piece and a complementary female element, which are connected together by mating one in the other. The female element is generally connected to an upstream pipe and is provided with a closure valve that the male end piece manoeuvres towards an open position when it is mated with this female element. The male end piece is generally connected to a downstream pipe. After this mating, the upstream and downstream pipes are joined together and the fluid can flow from one pipe to the other.

For the male end piece mated with the female element to be kept in the axial position, it is known to employ a mechanism comprising locking balls, such as that illustrated by FIG. 6 of FR-A-2 882 803. The locking balls cooperate with a locking groove provided on the end piece so as to prevent the latter from moving. Each locking ball is thus able to move radially between an unlocked position, in which it can occupy a seat associated with the female element, and a locked position in which it is capable of blocking the end piece axially.

It is also known to provide on the female element an annular locking element that can form a ring for keeping each locking ball radially in place in the locked position in which the balls block the end piece. Since the annular element or the lock ring can generally move in axial translation relative to the balls owing to the effect of a resilient element, certain connectors of the prior art incorporate a safety ring that can move axially and is intended to keep the locking balls radially in place in the unlocked position, until the end piece has mated with the female element.

In the unlocked position, the locking balls constitute an obstacle to the axial displacement of the lock ring. When the end piece is fitted into the female element, it pushes the safety ring back axially towards the upstream pipe. This releases the locking balls, which move radially in a centripetal manner in the locking groove so as to prevent the end piece from moving. The locking balls thus release the lock ring, which moves axially and covers the balls so as to prevent them from returning to the unlocked position.

However, a female element of a connector constructed in this way has a large overall axial length. This overall length is the sum of the length of the safety ring, the length of its axial travel and the length of the end piece which is mated with the body of the female element.

Furthermore, such a connector may be unreliable as it is not necessary to bear uniformly over the entire, generally annular, cross section of the safety ring in order to move it axially. In particular, when the end of the end piece to be mated is very long, it is possible to push the safety ring back axially by introducing the end piece in a tilted manner, hence without bearing on the entire cross section of the ring. In this case, the locking balls may be brought into the locked position and thus release the lock ring without correspondingly engaging the end piece. The end piece may then be withdrawn while the lock ring is in the locked position. In this position, it is no longer possible for the end piece to be automatically connected without having beforehand brought the lock ring manually back into the unlocked position.

Moreover, the addition of an axial safety ring between the locking ball and the mating channel for the end piece is not compatible with a female element in which the lock ring remains stationary, while an intermediate adapter that has to be locked by the balls with the end piece moves into it. This is because the incorporation of a safety ring into such a female element would substantially increase its radial dimension or would weaken the intermediate piece for a given radial dimension. In addition, the springs acting on the safety ring and on the adapter, for bringing them back to the unlocked position, would exert forces directed in the same direction, thereby requiring a very precise construction in order to obtain successive and non-simultaneous axial displacements of these components.

Moreover, U.S. Pat. No. 5,230,538 or EP-A-0 707 171 discloses a female connector element with an axial channel for a male end piece, an annular locking element and locking balls that can move axially relative to the annular element and radially between locked and unlocked positions.

The female element of U.S. Pat. No. 5,230,238 or EP-A-0 707 171 comprises an annular resilient strip forming an obstacle to the axial displacement of the lock ring. Such a geometry makes such an obstacle large both radially and axially. This weakens the female element if the dimensions are kept constant. Furthermore, the geometry of the obstacle devices of U.S. Pat. No. 5,230,238 and EP-A-0 707 171 is relatively complex, making them expensive to manufacture.

The object of the invention is most particularly to remedy these drawbacks by providing a female connector element comprising a device capable of detecting that the end piece in the mating channel is of correct geometry and in a correct position.

For this purpose, one subject of the invention is a female element for a connector, having a channel extending axially and intended to accommodate a male end piece, the female element having an annular element for locking the end piece and at least one locking ball for locking the end piece that can move axially relative to the annular element and radially between an unlocked position, in which said ball is capable of occupying a bearing seat provided in the annular element, and a locked position, in which it is guided radially in a body of the female element and in which it is capable of axially blocking the end piece in the body, the female element further including:
at least one device forming an obstacle to the axial displacement of the annular element relative to the locking ball in the unlocked position, said device being radially retractable;
at least one resilient element for returning said device to the unlocked position; and
at least one detection member for detecting the end piece, placed radially between the channel and said device, the detection member being capable, in the unlocked position, of being moved away radially by the end piece so as to retract the device,
wherein said device and the resilient element consist of a stop clip in the form of a resilient ring consisting of a wire of generally circular cross section.

Thanks to the invention, a compact and security-protected coupling of the end piece in the female element is achieved, thereby preventing defective locking and any induced leakage.

According to other advantageous but not obligatory features of the invention, taken in isolation or in any technically possible combination:
the female element comprises several detection members distributed on the periphery of the channel and capable of being moved radially away by the end piece so as together to retract the device;
the locking ball lies between the detection member and a mouth of the channel intended to accommodate a male end piece;
the device can be retracted along the centrifugal direction into at least one housing provided in the annular element;
the detection members can move radially outwards relative to the female element so as to retract the device;
the detection member is a ball;
the stop clip is accommodated in an annular groove of the female element in the unlocked position, the axial dimension of the annular groove being greater than the diameter of the wire of the stop clip and the depth of the annular groove being less than the diameter of the wire of the stop clip, whereas in the locked position, the stop clip is retracted away from the annular groove;
the depth of the annular groove is greater than one half of the diameter of the wire of the stop clip;
the female element has at least one cavity intended to accommodate a detection member and the annular groove is offset axially towards the mouth of the channel relative to the centre of the or each cavity;
the annular element is integral with the female element, the body is mounted so as to slide axially in the female element, the body defining the channel and having cavities capable of accommodating the locking ball and the detection member, and the female element includes a stop mechanism capable of preventing the body from moving axially relative to the annular element; and
the annular element is mounted so as to slide axially relative to the body of the female element between the locked position and the unlocked position and the female element includes an elastic member for returning the annular element to the locked position.

The subject of the invention is also a quick-fit connector for joining two pipes, which comprises a female element and an end piece, wherein the female element is as explained above and wherein the end piece has a locking groove capable of accommodating the or each locking ball, and an external part capable of moving the detection member radially away so as to retract the obstacle-forming device.

The invention will be well understood and other advantages thereof will become more clearly apparent in the light of the following description given solely by way of example and with reference to the appended drawings in which:

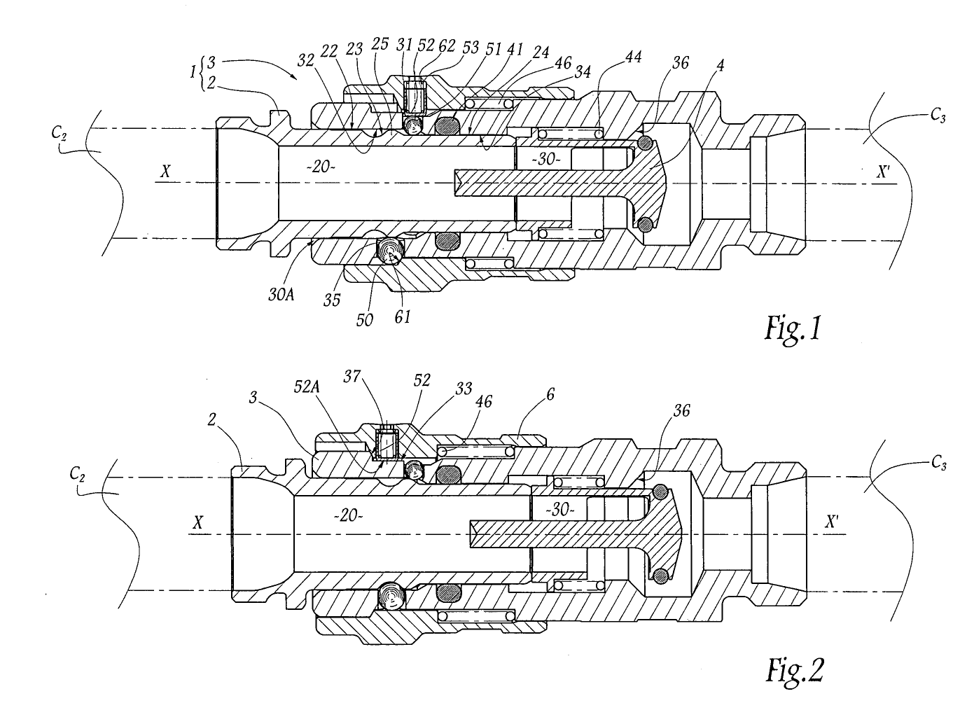

FIG. 1 is a cross section of a connector according to a first embodiment, comprising a female element in which an end piece is in an intermediate position, the movable components of the female element each being in the unlocked position;

FIG. 2 is a cross section similar to FIG. 1 in which the end piece and the movable components of the female element are in the locked position;

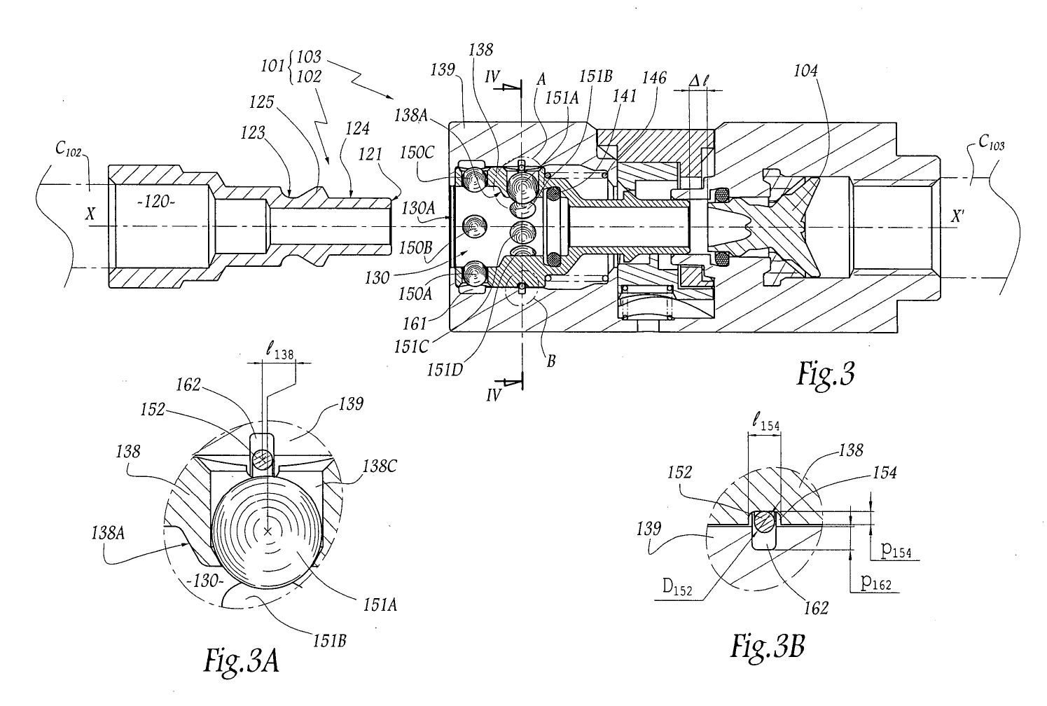

FIG. 3 is a cross section of a connector according to a second embodiment of the invention, comprising a female element according to a second embodiment of the invention and an end piece in the uncoupled position, the movable components of the female element each being in the unlocked position;

FIG. 3A is a view on a larger scale of detail A in FIG. 3;

FIG. 3B is a view on a larger scale of detail B in FIG. 3;

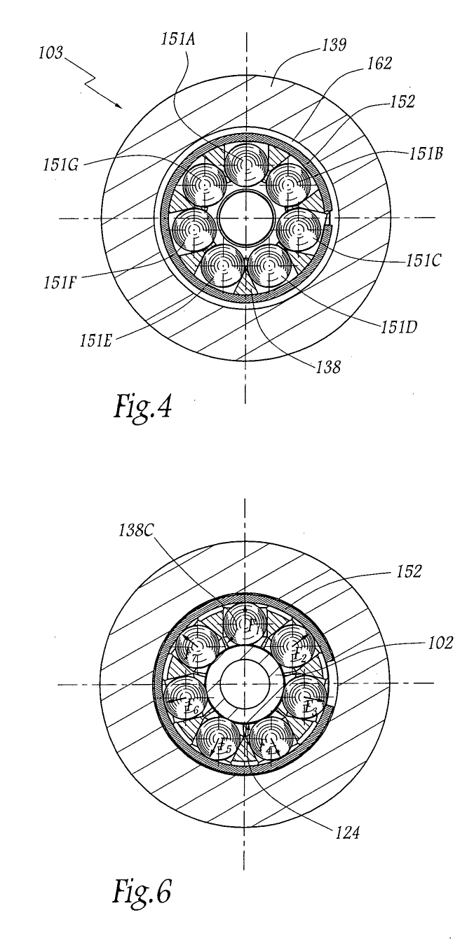

FIG. 4 is a cross section on the line IV-IV of the female element in FIG. 3;

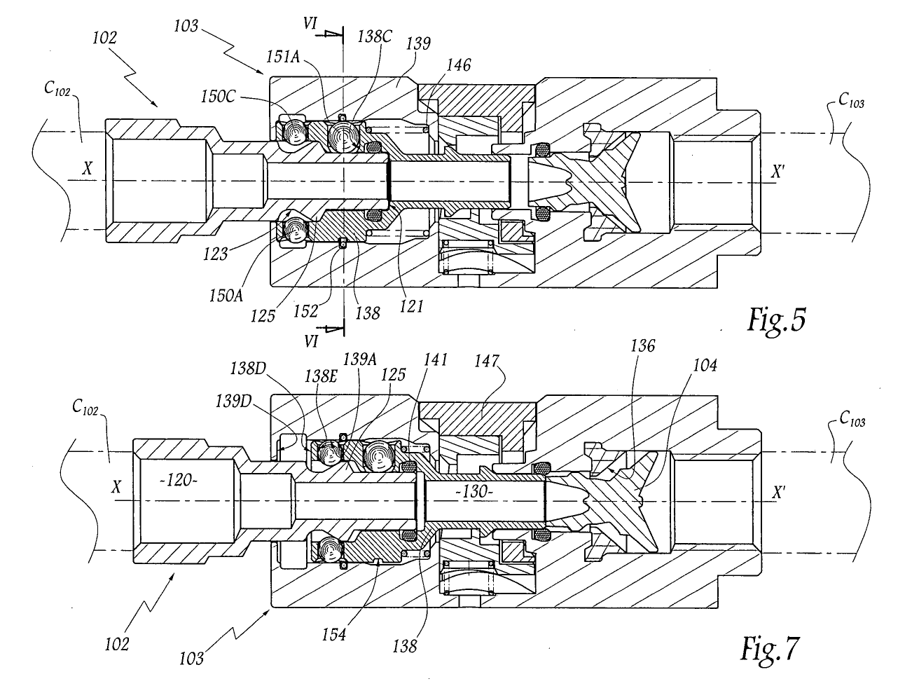

FIG. 5 is a view similar to FIG. 3 in which the end piece is in the process of being coupled into the female element;

FIG. 6 is a cross section on the line VI-VI in FIG. 5; and

FIG. 7 is a cross section similar to FIGS. 3 and 5 showing the coupled connector with its components in the locked position.

FIG. 1 shows a connector 1 comprising an end piece 2 constituting the male element of the connector 1 and a female element 3 that are partially mated, one in the other, along the axis X-X′. The end piece 2 is connected to a fluid pipe C₂, shown by the dot-dash lines, whereas the female element 3 is connected to a fluid pipe C₃, also shown by the dot-dash lines. The end piece 2 defines a longitudinal passage 20 through which the fluid can flow. The external radial surface of the end piece 2 has a proximal portion 22 of relatively large diameter and a distal portion 24 of smaller diameter. Lying between the proximal portion 22 and the distal portion 24 are an annular groove 23 and a distal annular collar 25.

A surface is termed here “radial” or “axial” according to the orientation of a normal to this surface. In addition, a radial surface is termed to be “internal” if it is turned towards the X-X′ axis and “external” if it is turned in the opposite direction. The adjective “proximal” denotes an element of a piece close to the pipe to which this piece is connected, whereas the adjective “distal” denotes an element which is further away therefrom.

The female element 3 defines a channel 30 of shape complementary to the proximal 22 and distal 24 portions of the end piece 2 so as to allow coupling of the connector 1. The female element 3 also houses a valve 4 intended to close off the channel 30 when the connector is uncoupled. That part of the channel 30 which is intended to accommodate the end piece 2 includes a distal bore 32 having a diameter complementary to that of the proximal portion 22 and a proximal bore 34 having a diameter complementary to that of the distal portion 24.

In the intermediate coupling position illustrated by FIG. 1, the distal end of the end piece 2 abuts a distal part of the valve 4 and pushes the latter back, against an elastic closure force exerted by a spring 44, off its seat 36 provided in the female element 3. The fluid can then flow from the upstream pipe C₃ to the downstream pipe C₂ through the channel 30 and the longitudinal passage 20. The terms “upstream” and “downstream” refer to the direction of flow of the fluid from the pipe C₃ to the pipe C₂. The other direction of flow is also conceivable, and the terms “upstream” and “downstream” would then be reversed.

The coupling of the end piece 2 in the female element 3 is accomplished by means of a translation along the X-X′ axis, which also constitutes an axis of revolution both for the end piece 2 and for the channel 30. The longitudinal passage 20 extends axially along the X-X′ axis. An O-ring seal 41 is mounted in an internal radial groove of the female element 3 so as to ensure sealing on the end piece 2 when it is mated with the channel 30.

The female element 3 includes locking balls distributed around the X-X′ axis, one of which can be seen in FIG. 1 with the reference 50. As may be seen by comparing FIGS. 1 and 2, the locking ball 50 can move radially, that is to say along an axis perpendicular to the X-X′ axis. In the unlocked position illustrated in FIG. 1, an external part of the locking ball 50 is capable of occupying a bearing seat 61 provided in a ring 6 that forms an annular locking element, whereas, in the locked position, an internal part of the locking ball 50 is engaged in an annular locking groove 23 provided on the external radial surface of the end piece 2.

The middle part of the locking ball 50 is guided radially in a cavity 35 provided in the female element 3. In the locked position illustrated by FIG. 2, the locking ball 50 is capable of preventing the end piece 2 from moving axially, since the locking groove 23 has a partially toroidal profile with a radius complementary to the radius of the locking ball 50.

The ring 6 of the female element 3 includes a pin 52 constituting a device forming an obstacle to the axial displacement of the ring 6 relative to the locking ball 50 when said ring and said ball are in the unlocked position. In this position, the internal end of the pin 52 is in contact with a first axial abutment surface 31 of the female element 3, whereas the external part of the pin 52 is partially fitted into a housing 62 provided in the ring 6. The pin 52 and the housing 62 each have the shape of a right cylinder with a circular base. The pin 52 can be retracted into the housing 62 so as no longer to form an obstacle to the sliding of the ring 6, the latter then being able to move to its locked position.

The female element 3 also includes a member for detecting the end piece 2, said member consisting here of several balls, one of which can be seen in FIGS. 1 and 2 with the reference 51. The detection ball 51 is placed, in a radial direction, between the channel 30 and the pin 52. The locking balls 50 lie in an axial direction between the detection balls 51 and the mouth 30A via which an end piece of the 2 kind is introduced. In the unlocked position, the detection ball 51 is facing and contacting the pin 52, which pushes the detection ball 51 back towards the channel 30 under the effect of a resilient element, in this case a helical compression spring 53, mounted in the housing 62. The housing for the detection ball 51 in the female element 3 includes an abutment for radial displacement of the detection ball 51 towards the X-X′ axis. Thus, in the unlocked position, the internal part of the detection ball 51 projects into the channel 30, more precisely into the volume of the female element 3 that the end piece 2 occupies in the locked position. Likewise, the other balls (not shown) face each pin 52 respectively.

During coupling of the connector 1, the end piece 2 is introduced into the channel 30, and its distal portion 24 and its annular collar 25 push the locking ball 50 and the equivalent balls back, without any effort, along a radial direction, into the cavity 35 and towards the bearing seat 61. When the locking groove 23 reaches the point facing the locking ball 50, simultaneously the annular collar 25 moves the detection ball 51 radially away, out of the channel 30. More precisely, the annular collar 25 pushes the detection ball 51, and therefore the pin 52, back in a radial direction towards the outside and against the spring 53 so as to release the volume occupied by the end piece 2 in the locked position.

In other words, the detection members formed by the standard balls 51 distributed around the X-X′ axis detect, in the manner of a sensor, the relief that the annular collar 25 forms. Each detection ball 51 therefore transmits its radial movement to a pin 52 and retracts it into the housing 62 as far as a radial position in which the pin 52 no longer forms an obstacle to the sliding of the ring 6 along the female element 3. The ring 6 then pushes, via the shoulder forming the bearing seat 61, the locking ball 50 back into the locking groove 23.

Simultaneously, the internal terminal surface 52A of the pin 52, pushed back by the spring 53, slides on a guiding flat 33 provided on the external surface of the female element 3 until there is contact between an approximately axial annular surface of the ring 6 and a second axial abutment surface 37 of the female element 3. After a substantial part of the pin 52 has been retracted, the sliding of the ring 6 takes place under the effect of a resilient member, in this case a helical spring 46, which returns the ring 6 to the locked position. It is therefore sufficient to retract the pin 52 to the height of the guiding flat 33, and not entirely, into its housing 62. In this locked position, the ring 6 covers the locking ball 50 and keeps it in place in the locking groove 23, thus preventing the end piece 2 from moving axially in the female element 3. The relative movement between the locking ball 50 and the ring 6, between the unlocked configuration and the locked configuration, is therefore radial and axial.

To uncouple the end piece 2 from the female element 3, an operator must bring the ring 6 into its unlocked position and keep it there, that is to say move it towards the pipe C₃, thereby making it possible simultaneously to release the locking ball 50 from the locking groove 23 and to reposition the pin 52 facing the detection ball 51. The operator then removes the end piece 2 from the channel 30, so that the annular collar 25 loses contact with the detection balls 51. Each detection ball 51 is then pushed back radially towards the channel 30 by the corresponding pin 52 under the action of the spring 53. The pin 52 then forms again an obstacle to the sliding of the ring 6 towards the locking position. Next, the end piece 2 is completely removed and each movable component of the female element 3 is again in the unlocked position. The female element 3 is available for a further automatic connection.

The detection balls 51 here are distributed uniformly on the periphery of the channel 30. The detection balls 51 can move essentially in a radial direction relative to the female element 3. The detection balls 51 then cooperate to detect in a uniform manner the relief of the end piece 2, as it is necessary for each obstacle-forming pin 52 to be retracted radially, by an appropriate radial centrifugal displacement of each detection ball 51 into a corresponding housing. In such a construction, the detection balls 51 are pushed radially back towards the X-X′ axis by as many springs, in the manner of the pin 52 and the spring 53.

Thus, when several detection members for detecting the end piece 2 are distributed around the X-X′ axis, the reliability of the connector 1 is increased, as it becomes necessary to act simultaneously on all the detection members in order to release the ring 6. In particular, at least two diametrically opposed ball/pin assemblies in the ring 6 are then necessary to ensure the outside diameter of the end piece 2 matches with the diameter of the channel 30. The more detection members there are, preferably uniformly distributed around the X-X′ axis, the greater the reliability of the connector and the lower the risk of erroneous or defective coupling. As a variant, the pins 52 may have a non-circular base.

FIGS. 3 to 7 illustrate a second embodiment of the invention in which the corresponding functional or structural elements bear the same references but increased by 100. The differences lie, on the one hand, in the construction of the female element and of the annular locking element and, on the other hand, in the structure of the device forming the obstacle to locking.

The connector 101 comprises a end piece 102 connected to a pipe C₁₀₂, shown by the dot-dash lines and intended to be mated with a channel 130 of the female element 103, which is connected to a pipe C₁₀₃ shown by the dot-dash lines.

More precisely, the female element 103 has a bore in which an adapter 138 forming an intermediate component is mounted, said component sliding along the mating axis X-X′ of the parts 102 and 103. The adapter 138 defines the channel 130 having a shape complementary to the external radial surface of the end piece 102. The adapter 138 performs the functions of receiving the middle part of the locking balls 150A-150C and of radially guiding the detection balls 151A-151G that are devolved upon the body of the female element 3 in the first embodiment. FIGS. 4 and 6 show all the detection balls 151A-151G, while FIG. 3 shows four of them, namely 151A-151D, and FIGS. 5 and 7 show only one of them, namely 151A. In addition, the female element 103 has a body 139 that forms an annular locking element and performs the functions devolved upon the ring 6 in the first embodiment.

The female element 103 includes four locking balls uniformly distributed around the X-X′ axis, three of which can be seen in FIG. 3 with the references 150A, 150B and 150C. The locking balls 150 lie in the axial direction between the detection balls 151 and the mouth 130A via which an end piece of the 102 kind is introduced. As it is being introduced into the channel 130, the end piece 102 is able to push, without major effort, the locking balls 150A-150C back into the respective bearing seats 161 consisting here of a common annular groove made in the body 139. The distal end of the end piece 102 then abuts the detection balls 151A-151G, which project into the channel 130, that is to say into the volume of the adapter 138 that the end piece 102 occupies in the locked position, towards which said detection balls are pushed elastically. The seven detection balls 151A-151G are uniformly distributed around the X-X′ axis.

The device forming an obstacle to the axial displacement of the locking balls 150A-150C relative to the body 139 constituting the annular locking element consists here of a generally annular stop clip 152. The device forms an obstacle over a major part of the circumference of the body 139 and therefore consists of a single piece unlike pins 52, which form multiple local obstacles in the connector.

In the unlocked position, the stop clip 152 is engaged, on the one hand, with the adapter 138 and, on the other hand, with the body 139. The stop clip 152 is indeed placed in an annular groove 154 provided on the external radial surface of the adapter 138. The stop clip 152 is also partially placed in a housing 162 consisting of an annular groove provided in the bore of the body 139. The stop clip 152 thus blocks the relative axial displacement between the body 139 and the adapter 138 and keeps the locking balls 150 in place facing the bearing seats 161.

As in the connector 1, the detection balls 151A-151G, placed radially between the channel 130 and the stop clip 152, are capable of radially retracting the stop clip 152 outwardly into the housing 162 when they are moved away radially by the distal external radial surface 124 of the end piece 102 towards the body 139 out of the channel 130. The radial forces exerted by the detection balls 151, each moved radially, on the stop clip 152 are shown symbolically in FIG. 6 by the arrows F₁ to F₇. The stop clip 152 is made up of a metal wire having a generally circular cross section, cut and shaped in the form of a resilient ring of approximately toroidal shape. During its retraction, the ring forming the stop clip 152 expands, at its inside torus diameter and under the radial forces exerted by the detection balls 151 uniformly distributed around the X-X′ axis, as may be seen by comparing FIGS. 4 and 6. The sliding of the adapter 138 in the body 139 is then no longer blocked by the stop clip 152.

Next, when the locking groove 123 of the end piece 102 faces the locking balls 150, the end piece 102 comes into abutment against the adapter 138 and pushes it back against the helical spring 146 over a travel Δl until there is contact between the adapter 138 and a valve 104 of the female element 103. To do this, the adapter 138 has a shape complementary to that of the end piece 102 and has in particular a shoulder 138A capable of cooperating with the distal axial face of an external radial annular collar 125 of the end piece 102.

The adapter 138 moves axially towards the pipe C₁₀₃, taking with it the locking balls 150 and the detection balls 151. The locking balls 150 then undergo, between the unlocked position and the locked position, an axial and radial movement relative to the body 139. The detection balls 151 lose contact with the stop clip 152, which remains held in place retracted in the housing 162 by the external radial surface of the adapter 138.

In this locked position, the locking balls 150A-150C are held in place in a locking groove 123 of the end piece 102, thus preventing it from moving axially relative to the adapter 138. As in the connector 1, the locking groove 123 lies behind the annular collar 125 on the external radial surface of the end piece 102, that is to say on the opposite side from an axial distal annular end 121 of the end piece 102 relative to this collar.

The adapter 138 pushes back the valve 104, which comes off its seat 136 and permits the fluid to pass from the pipe C₁₀₃ through the channel 130 and towards the pipe C₁₀₂ through the longitudinal passage 120 defined by the end piece 102. During its travel, the proximal part of the adapter 138 initiates a stop mechanism similar to that described by FR-A-2 882 803 and capable of preventing the adapter 138 from moving axially in the female element 103, which may subsequently be released by means of pressure on a button 147.

After coupling and locking, the fluid flows along the channel 130 and pushes the end piece 102 axially back towards the pipe C₁₀₂. The connector is then in the configuration shown in FIG. 7. A seal 141 provides sealing between the adapter 138 and the end piece 102. When the end piece 102 is pulled back, the proximal surface of the annular collar 125 butts against the locking balls 150. The latter are then jammed between the annular collar 125, the internal radial surface 139A of the bore of the body 139 and an axial annular surface 138E of the adapter 138, and they immobilize the end piece 102 in the adapter 138 in this operating position.

The groove forming the housing 162 has an axial length and a depth p₁₆₂ that are respectively greater than the diameter D₁₅₂ of the wire of the stop clip 152, so as to entirely house the latter in the configuration shown in FIGS. 7 and 3B. To fully retract the stop clip 152 in the housing 162, it is necessary for the stop clip 152 to be uniformly deformed over its entire circumference. This is why several detection balls 151 are employed, which are distributed, preferably uniformly, around the X-X′ axis, and are moved radially apart so as together to retract the stop clip 152. In other words, the retraction of the stop clip 152 is achieved only after an appropriate radial displacement or movement of each detection ball 151.

In addition, the stop clip 152 must be constructed so as to remain sufficiently rigid between two points of deformation by the detection balls 151. The stop clip 152 consists of an open ring made of a metal wire elastically deformed by the outwardly radial action of the detection balls 151 and which, without the action of the balls, spontaneously contracts to its rest position, that is to say in the direction of the X-X′ axis, so that it can exert an elastic force tending to bring the detection balls 151 back towards the channel 130. The stop clip 152 therefore intrinsically combines the obstacle and elastic return functions of the detection balls 151 in the unlocked position.

In order for the stop clip 152 to be in contact with the bottom of the annular groove 154, the latter has an axial length 1154 slightly greater than the diameter D₁₅₂ of the circular cross section of the wire of the stop clip 152 and a diameter at the bottom of the annular groove 154 slightly greater than the inside diameter of the stop clip 152, when the latter is in the rest configuration, not assembled with the connector. To allow the stop clip 152 to return to the bottom of the annular groove 154 upon unlocking the connector 101, each detection ball 151 has an appropriate radial clearance towards the channel 130. The detection balls 151 are held in place in the radial position in the adapter 138 by the narrowed conical bottom of each cavity 138C housing a detection ball 151.

Moreover, the depth p₁₅₄ of the annular groove 154 is smaller than the diameter D₁₅₂ so as to ensure that the stop clip 152 is simultaneously in contact with the adapter 138 and with the housing 162. In addition, the depth p₁₅₄ of the annular groove 154 may be greater than the radius D₁₅₂/2, in such a way that the stop clip 152 is more engaged with the adapter 138 than with the body 139, that is to say, as may be seen in the plane of FIG. 3A, the centre of the circular section of the wire constituting the stop clip 152 is located in the annular groove 154. Thus, sliding of the adapter 138 without the detection balls 151 moving radially apart, due to an object other than an appropriate end piece, generates an axial force of the body 139 applied on that part of the wire of the stop clip 152 which is located radially beyond the centre of the wire of the stop clip 152 and on the side of the housing 162. Such a force tends rather to bring the stop clip 152 back into the annular groove 154, and therefore does not allow it to be retracted into the housing 162.

The central axis of the annular groove 154 may be positioned with a slight offset l₁₃₈ towards the distal end of the adapter 138 relative to the centre of the cavities 138C accommodating detection balls 151. Owing to this offset l₁₃₈, typically around 0.15 mm for a clip with a wire diameter of the order of 1 mm, the axis of the detection balls 151, when they are pushed back radially towards the body 139, is slightly closer to the pipe C₁₀₃ than the centre of the circular section of the wire constituting the stop clip 152, which then cannot impede their displacement towards the pipe C₁₀₃.

To uncouple the connector 101, it is firstly necessary to unlock the stop mechanism of the adapter 138 by actuating the button 147, as described in FR-A-2 882 803. The compressed spring 146 can then push the end piece 102 back towards the mouth 130A.

The end piece 102 and the adapter 138, fastened together by the locking balls 150, together move back until there is contact between a distal terminal surface 138D of the adapter 138 and a distal abutment surface 139D of the body 139. The locking balls 150A-150C then face the bearing seats 161 and are free to disengage radially from the locking groove 123, thus unfastening the end piece 102 from the adapter 138. The detection balls 151 resume their places in contact with the stop clip 152.

The end piece 102 withdrawn by the operator can continue its rearward movement until the detection balls 151 are in turn released, which balls are brought back towards the channel 130 against the conical bottom of each cavity 138C by the elastic force exerted radially, in a centripetal manner, by the stop clip 152, which resumes its obstacle position at the bottom of the annular groove 154. The connector 101 is thus uncoupled, and the female element 103 is available for a new automatic connection with a end piece of the 102 kind.

The female element 103 has a tolerance to the variations in diameter of the end piece that is greater than that of the connectors of the prior art with annular strip, due to the shape in the form of a wire of circular cross section of the stop clip. This tolerance is required for the operation of the connector, because the detection members are different from the locking balls. If the radial external distal surface 124 of the end piece 102 detected by the detection balls 151 is machined with a weak dimension, the position reached by the detection balls 151 and by the stop clip 152 is close but not in the position in which the stop clip 152 gets retracted. However, any relative axial motion between the components in contact with the stop clip 152, under the coupling force, exerted for instance by the end piece 102 on the adapter 138, completes the retraction of the stop clip 152 by exerting a radial force on the stop clip 152 that pushes it back into the housing 162.

In addition, unlike the female elements of the prior art, the construction of the female element forming the subject of the invention remains compact. In the radial direction, a relatively small volume suffices for fitting the obstacle-forming device and its elastic return means. In the axial direction, the resilient ring requires a small amount of space compared with an obstacle-forming device of the connectors of the prior art.

A female element according to the present invention therefore provides greater reliability of the connection since its detection member(s) provides (provide) more reliable detection of the end piece.

This is because with a connector of the prior art in which the locking balls perform the function of detecting of the end piece, if the obstacle, such as a resilient annular strip, is retracted, while the end piece is being pulled back out of the female element before coupling, the lock ring may be pushed back axially by the return springs, thereby preventing a further automatic connection of the connector and requiring manual intervention in order to reposition it.

Unlike the known art with an axial safety ring, it is the external radial surface of the end piece and not its distal end that is detected. In particular, when the female element has several detection members uniformly distributed around its axis, the end piece must have an appropriate external cylindrical geometry so as to radially disengage at the same time all the detection members so as to retract the obstacle-forming device. The female element may also include several detection members distributed non-uniformly around its axis. Likewise, the locking balls may be distributed non-uniformly around the X-X′ axis.

Furthermore, the detection members are located upstream of the locking balls and therefore in a region travelled by the end piece after its passage between these balls. This guarantees that the end piece is sufficiently mated with and correctly oriented in the female-element before the locking operation takes place.

Moreover, the reliability of the connector forming the subject of the invention is also improved by the radial retraction of the obstacle-forming device at locking against radial elastic forces, thus preventing interference with the return springs acting in the axial direction.

Other embodiments are possible within the context of this invention. It is also possible to provide detection members made up of several pieces in order to retract the obstacle-forming device. The detection members may also have geometries other than those of balls.

Moreover, the implementation of an obstacle by a clip is possible in the female element of the first embodiment and the obstacle by pins can be adapted in the female element of the second embodiment of the invention.

1. Female element (103) for a connector (101), having a channel (130) extending axially (X-X′) and intended to accommodate a male end piece (102), the female element having an annular element (139) for locking the end piece (102) and at least one locking ball (150A-150C) for locking the ferrule (102) that can move axially (X-X′) relative to the annular element (139) and radially between an unlocked position, in which said ball is capable of occupying a bearing seat (161) provided in the annular element (139), and a locked position, in which it is guided radially in a body (138) of the female element (103) and in which it is capable of axially blocking (X-X′) the end piece (102) in the body (138), the female element (103) further including:
at least one device (152) forming an obstacle to the axial displacement (X-X′) of the annular element (139) relative to the locking ball (150A-150C) in the unlocked position, said device (152) being radially retractable;
at least one resilient element (152) for returning said device (152) to the unlocked position; and
at least one detection member (151A-151G) for detecting the end piece (102), placed radially between the channel (130) and said device (152), the detection member (151A-151G) being capable, in the unlocked position, of being moved away radially by the end piece (102) so as to retract the device (152),
wherein said device and the resilient element consist of a stop clip (152) in the form of a resilient ring consisting of a wire of generally circular cross section (D₁₅₂).

2. Female element (103) for a connector (101) according to claim 1, wherein said female element (103) comprises several detection members (151A-151G) distributed on the periphery of the channel (130) and capable of being moved radially away by the end piece (102) so as together to retract the device (152).

3. Female element (103) for a connector (101) according to claim 1, wherein the locking ball (150A-150C) lies between the detection member (151A-151G) and a mouth (130A) of the channel (130) intended to accommodate a male end piece (102).

4. Female element (103) for a connector (101) according to claim 1, wherein the device (152) can be retracted along the centrifugal direction into at least one housing (162) provided in the annular element (139).

5. Female element (103) for a connector (101) according to claim 2, wherein the detection members (151A-151G) can move radially outwards relative to the female element (103) so as to retract the device (152).

6. Female element (103) for a connector (101) according to claim 1, wherein the detection member is a ball (151A-151G).

7. Female element (103) for a connector (101) according to claim 1, wherein the stop clip (152) is accommodated in an annular groove (154) of the female element (103) in the unlocked position, the axial dimension (l₁₅₄) of the annular groove (154) being greater than the diameter (D₁₅₂) of the wire of the stop clip (152) and the depth (p₁₅₄) of the annular groove (154) being less than the diameter (D₁₅₂) of the wire of the stop clip (152), whereas in the locked position, the stop clip (152) is retracted away from the annular groove (154).

8. Female element (103) for a connector (101) according to claim 7, wherein the depth (p₁₅₄) of the annular groove (154) is greater than one half of the diameter (D₁₅₂) of the wire of the stop clip (152).

9. Female element (103) for a connector (101) according to claim 7, wherein said female element (103) has at least one cavity (138C) intended to accommodate a detection member (151A-151G) and wherein the annular groove (154) is offset (l₁₃₈) axially (X-X′) towards the mouth (130A) of the channel (130) relative to the centre of the or each cavity (138C).

10. Female element (103) for a connector (101) according to claim 1, wherein the annular element (139) is integral with the female element (103), wherein said body (138) is mounted so as to slide axially (X-X) in the female element (103), the body (138) defining the channel (130) and having cavities (138C) capable of accommodating the locking ball (150A-150C) and the detection member (151A-151G), and wherein the female element (103) includes a stop mechanism (147) capable of preventing the body (138) from moving axially relative to the annular element (139).

11. Female element (103) for a connector (101) according to claim 1, wherein the annular element (139) is mounted so as to slide axially (X-X′) relative to the body (138) of the female element (103) between the locked position and the unlocked position and wherein the female element (103) includes an elastic member (146) for returning the annular element (139) to the locked position.

12. Quick-fit connector (101) for joining two pipes (C₁₀₂-C₁₀₃), which comprises a female element and an end piece (102), wherein the female element (103) is according to claim 1 and wherein the end piece (102) has a locking groove (123) capable of accommodating the or each locking ball (150A-150C), and an external part (125; 124) capable of moving the detection member (151A-151G) radially away so as to retract the obstacle-forming device (152).
